(19) United States
(12) Patent Application Publication
(10) Pub. No.: US 2026/0197292 A1
(43) Pub. Date: Jul. 9, 2026

(54) USING BLOOM FILTERS TO INVOKE A SERVER ACTION

(71) Applicant: Telefonaktiebolaget LM Ericsson (publ), Stockholm (SE)

(72) Inventors: Petri LAARI, Espoo (FI); Oscar NOVO DIAZ, Vilassar de Mar (ES); Ari KERÄNEN, Helsinki (FI); Jaime JIMÉNEZ, Espoo (FI)

(73) Assignee: Telefonaktiebolaget LM Ericsson (publ), Stockholm (SE)

(21) Appl. No.: 19/132,082

(22) PCT Filed: Nov. 23, 2022
(86) PCT No.: PCT/SE2022/051089

§ 371 Date: May 22, 2025

(51) Int. Cl. H04L 61/00; H04L 67/51

(52) U.S. Cl. CPC H04L 61/35; H04L 67/51

(57) ABSTRACT

A method (500) performed by a server capable of being requested by a client to perform one or more actions. The method includes obtaining a first identifier, Id_1, wherein the first identifier is associated with a first action. The method also include obtaining a second identifier, Id_2, wherein the second identifier is associated with a second action. The method also includes receiving a request message transmitted by the client, the request message comprising a bloom filter. The method also includes determining that Id_1 is included in the bloom filter. The method also includes, after determining that Id_1 is included in the bloom filter, performing the first action. The method also includes determining whether Id_2 is included in the bloom filter. The method also includes, if it is determined that Id_2 is included in the bloom filter, then performing the second action.

### TECHNICAL FIELD

Disclosed are embodiments related to the use a bloom filters in a client/server system where the client can send a bloom filter to the server to invoke one or more actions at the server.

### BACKGROUND

### Bloom Filters

A Bloom filter (BF) is a probabilistic data structure that can be used by a first device to identify to a second device in an efficient manner one or more known data items (i.e., a “set” of known data items”) selected by the first device. For example, if a first device wants to inform the second device that one or more of three possible known data items have been selected by the first device, the first device initializes a Bloom filter and then “adds” to the Bloom filter each selected data item. After receiving the Bloom filter, for each one of the three possible data items, the second device “queries” the bloom filter to determine if the data item is included in the Bloom filter. Due to the probabilistic nature of Bloom filters, there is a controllable level of uncertainty in the result of the query: the negative answer is always correct, but a positive answer may be a false positive.

### Adding Items to the BF and Querying the BF

FIG. 1 provides an illustrative example of a Bloom filter 102. In FIG. 1, a first data item (“Data 1”) 104 and a second data item (“Data 2”) 106 from a set of known data items that includes Data 1, Data 2, and Data 3 (i.e., a third data item 108) are inserted into the Bloom filter 102. After which a “query” process (a.k.a., “verification process”) is performed to check if Data 1 104 and Data 3 108 are included in the Bloom filter 102. Generally, a Bloom filter is an m-bit string which is initialized to 0 and then, for each data item added to the Bloom filter, modified accordingly. A data item from a known set of data items is added to the filter by hashing the data item using k different hash functions to produce k index values. As an example, FIG. 1 shows using three hash functions to insert Data 1 104 and Data 2 106 into the Bloom filter 102. The selection of hash functions depends on the implementation, but once the hash functions have been selected, the same set of functions is used during the lifetime of the Bloom filter.

Each of the hash operations results in an integer value between 1 and m (or between 0 and m−1) (this value is referred to as an “index” value). The resulting k index values are used as indexes to the Bloom filter. More specifically, for each of the k index values, the bit in the Bloom filter that corresponds to the index value is set to 1 (e.g., if the index values range between 1 and m and if one of the k index values is 7, then the seventh bit of the Bloom filter is set to 1). If an indexed bit in the Bloom filter is already set to 1 due to some previously added data item, the bit is left unmodified. Once all the desired data items from the known set of data items have been inserted in the Bloom filter, the Bloom filter can be transmitted to another device, which then uses the Bloom filter to determine the data items that are “identified” by (or “included in”) the Bloom filter. Due to the possibility of false positives, the fact that a Bloom filter identifies a particular data item does not necessarily mean that the creator of the Bloom filter added the particular data item to the Bloom filter.

To determine whether the Bloom filter identifies a particular data item from the known set of data items, the device receiving the Bloom filter determines the k different index values using the particular data item and the k hash functions. The Bloom filter “identifies” the particular data item if, and only if, for each of the k index values, the corresponding bit in the Bloom filter is set to 1. Thus, if any of the corresponding bits are set to 0, the Bloom filter does not identify the data item (i.e., the device receiving the Bloom filter will know that the particular data item was not added to the Bloom filter by the creator of the Bloom filter). As noted above, there mere fact that the Bloom filters identifies a particular data item from the set of known data items does not necessarily mean that the creator of the Bloom filter added the particular data item to the Bloom filter.

In general, there are two kinds of false answers. A verification could result in a positive answer even though the data item has not been inserted into the filter. This means all the bit locations are 1 but the 1's were generated by inserting two or more different data items in the filter. This is called a false positive answer. False negative, in turn, occurs when the verification results in a negative answer even if the data item has been inserted in the filter. In a Bloom filter this would mean that there is 0 in some bit position that should be 1.

In this case, however, a Bloom filter can never return a false negative answer (assuming, of course, that the Bloom filter has not been corrupted). If the insertion and verification have been done correctly, all the bits of an inserted data item are 1 and verification of the same data item must return a positive answer. On the other hand, false positives are possible as seen in FIG. 1 when verifying Data 3 108. As a result of inserting Data 1 104 and Data 2 106, the k index bits calculated from Data 3 108 are all set to 1, providing a wrong answer when verifying Data 3 108.

Due to possible false positives, there is a non-zero probability that the Bloom filter identifies a data item even if the data item was not expressly added to the Bloom filter. This probability depends on many parameters including the number of bits in the Bloom filter, the number of hash operations k per data item, and the number of data items that have been added to the filter. Generally, the more bits set to 1 in the Bloom filter, the greater the probability for false positives.

The false positive probability can be calculated using the equation below with size m, number of hash functions k, and number of items inserted in the filter n:

$$P = {( 1 - {( 1 - \frac{1}{m} )}^{kn} )}^{k} \approx {( 1 - {e}^{-} \frac{kn}{m} )}^{k}$$

Increasing the size of the filter provides better results (i.e., reduces the chance of a false positive). However, the implementation environment may set limits to the size of the Bloom filter. Also, increasing the number of elements inserted in the Bloom filter will increase the false positive probability. In addition to adjusting the size of the filter, the number of hash functions used can be optimized to achieve a better result.

### Internet of Things

The Internet of Things (IoT) has emerged as one of the most important computing disciplines over the last few years. The term Internet of Things denotes the ability to connect any physical object in the world to the Internet to communicate and share information with other devices and systems in a network.

The capabilities of IoT have enabled the extension of the Internet to devices of all types, ranging from home appliances, medical devices, and industrial systems to connected vehicles. Moreover, most of those devices have strict limits in terms of energy consumption, memory, and processing capabilities. As a result, the vast majority of the IoT technologies have been designed with such requirements in mind to minimize their overhead.

The characteristics of IoT devices (particularly IoT devices with limited or restricted capabilities) include their availability to consume very little power over very long periods of time. Such devices optimize their power consumption by limiting their memory, processing, and communication capabilities. In certain cases, these devices might even automatically power off for brief periods of times to save energy. Those states of inactivity are called sleep modes and they are equivalent of pausing the state of the device for a specific amount of time. Furthermore, the constrained devices can, in some use cases, be classified into two distinct categories: sensors and actuators. Sensors are devices which can sense the physical environment and detect their changes, while actuators provide a mechanical action in respond to an input. In some cases, a constrained device can be a sensor and an actuator at the same time.

### SUMMARY

Certain challenges presently exist. For instance, existing IoT network information delivery systems are too resource intensive compared to the resources available to IoT devices.

Accordingly, in one aspect there is provided a method performed by a server (e.g., an IoT device) capable of being requested by a client to perform one or more actions. The method includes obtaining a first identifier, Id_1, wherein the first identifier is associated with a first action. The method also includes obtaining a second identifier, Id_2, wherein the second identifier is associated with a second action. The method also includes receiving a request message transmitted by the client, the request message comprising a bloom filter. The method also includes determining that Id_1 is included in the bloom filter. The method also includes, after determining that Id_1 is included in the bloom filter, performing the first action. The method also includes determining whether Id_2 is included in the bloom filter. The method also includes, if it is determined that Id_2 is included in the bloom filter, then performing the second action.

In another aspect there is provided a method for communicating to at least a first server information identifying a set of interaction capabilities (e.g. a set of resources), the set of interaction capabilities comprising a first interaction capability and a second interaction capability. The method includes obtaining a first identifier, Id_1, identifying the first interaction capability. The method also includes obtaining a second identifier, Id_2, identifying the second interaction capability. The method also includes deriving a first bit string, B_1, where B_1 is equal to (Id_1|Id_2), and | is a bitwise OR operator. The method also includes transmitting a request message comprising B_1 or B_2, where B_2 is a bit string derived using B_1.

In some aspects, there is provided a computer program comprising instructions which when executed by processing circuitry of an apparatus (e.g., IoT device) causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of embodiments disclosed herein is that the embodiments allow for increasing the throughput of constrained networks, for example, by reducing the size of request messages. A single request message can contain multiple “requests” in one bloom filter improving the performance of IoT devices with constrained resources, such as limited memory and battery size. Hence, embodiment improve the battery life of IoT devices.

### BRIEF DESCRIPTION OF THE DRAWINGS

The accompanying drawings, which are incorporated herein and form part of the specification, illustrate various embodiments.

FIG. 1 illustrates a bloom filter according to an embodiment.

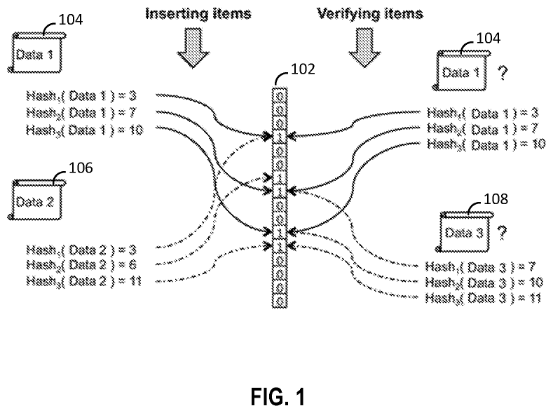

FIG. 2 illustrates a system according to an embodiment.

FIG. 3 illustrates a system according to an embodiment.

FIG. 4 illustrates an exchange according to another embodiment.

FIG. 5 is a flowchart illustrating a process according to an embodiment.

FIG. 6 is a flowchart illustrating a process according to an embodiment.

FIG. 7 is a block diagram of a client according to an embodiment.

### DETAILED DESCRIPTION

A Bloom filter is a data structure designed to identify the presence of an element in a set, in a memory efficient manner. In the embodiments disclosed herein, a Bloom filter is used by a first device (hereafter “client”) to convey information to a second device (hereafter “server”). For example, in one embodiment, the client adds to a Bloom filter one or more identifiers selected from a known set of identifiers and then sends the Bloom filter to the server, which then, for each identifier included in the known set of identifiers, determines whether the Bloom filter includes the identifier.

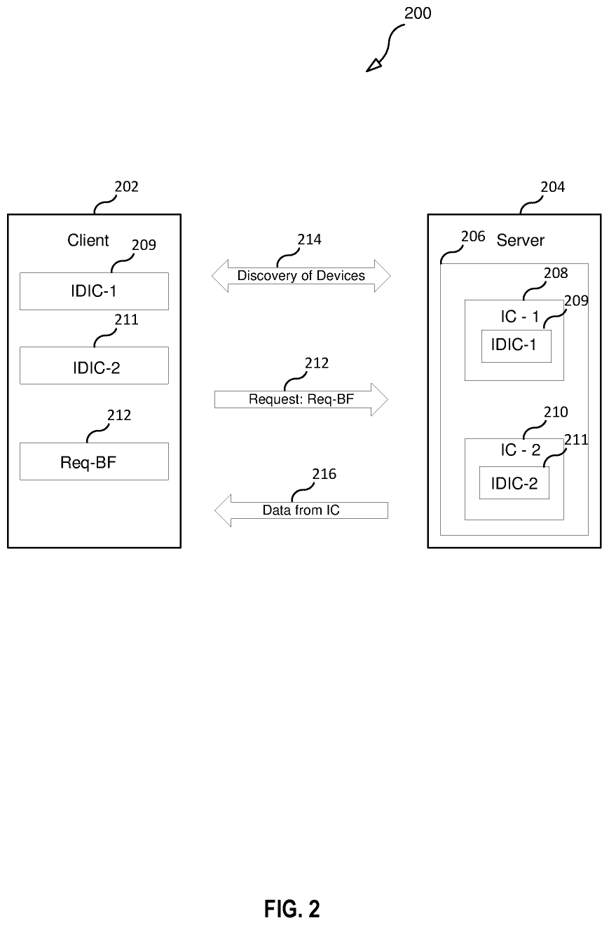

FIG. 2 illustrates a client 202 in communication with a server 204. The server 204 may be embodied as any type of device including IoT devices. In the present embodiment, the server 204 has one sensor 206 which has two interaction capabilities (IC-1 208, and IC-2 210) that can be addressed by the client 202. In other embodiments, the server 204 may include any number of devices and any type of device, including sensors or actuators. Sensor 206 may have any number of interaction capabilities. For example, the interaction capabilities may include: providing to the client the current value produced by the sensor (e.g., a current temperature value produced by a temperature sensor), providing to the client a minimum measured value (e.g., the lowest temperature recorded by the sensor since the value was reset); resetting the minimum measured value; etc.

In one embodiment, each interaction capability is uniquely associated with an m-bit long interaction capability identifier (IDIC), where k of the m bits are set to one. For example, as shown in FIG. 2, a first IDIC (IDIC-1) 209 is uniquely associated with IC-1 208 and a second IDIC (IDIC-2) 211 is uniquely associated with IC-2 210. Accordingly, each IDIC represents an interaction capability that may be requested by the client 202. For example, if client 202 desires server 204 to perform an action associated with IC-1 208 and an action associated with ID-2 210, client 202 initializes a Bloom filter (a.k.a., Req-BF 212) and then adds to Reg-BF 212 IDIC-1 209 and IDIC-2 211 (e.g., adding an IDIC-1 and IDIC-2 to Req-BF may comprise performing the OR operation: Req-BF=IDIC-1 OR IDIC-2). Once the Req-BF 212 is ready, it is sent to the server 204.

An IDIC can be assigned to an interaction capability (ICs) in a variety of ways, but, in any event, the set of available IDICs and the mapping from an IDIC to an interaction capability are known both to the server 204 and the client 202. In some embodiments, the mapping of IDICs to ICs may be communicated during a device discovery process 214 between the client 202 and the server 204.

Upon receiving a request message comprising Req-BF 212, server 204 determines the IDICs that are identified by (i.e., included in) the Req-BF 212. In some embodiments, the server determines this by:

For each of the IDIC-x that the server 204 has, do:

$$Result = ( Req - BF ) AND ( IDIC - x ) XOR ( IDIC - x ) .$$

If Result is equal to 0, then IDIC-x is determined to be included in the Req-BF.

In other embodiments, the comparison uses the following formula:

For each of the IDIC-x 210 that the server 204 has, do:

$$Result = ( Req - BF ) AND ( IDIC - x )$$

If Result=IDIC-x, then IDIC-x is identified by the Req-BF. After server 204 determines that Req-BF 212 includes IDIC-x (e.g., IDIC-1 or IDIC-2), then server 204 will perform an action associated with the IC identified by IDIC-x. For example, if server 204 determines that the Req-BF 212 includes IDIC-x and IDIC-x is associated with the IC of reading the current measured temperature, then server 204 will obtain the current temperature measurement and send to client 202 a response 216 containing the data from the IC (which in this example is a temperature measurement).

### Creating the IDIC

There are multiple ways to create IDICs for different ICs in a system. In some embodiments, the IDIC can be generated locally, for example using hash functions, or even randomizing the k number of bits, or they can be generated and assigned at a manufacturing phase.

In other embodiments, the same IDIC, for example, for all “Sensor Value” interaction capabilities may be used in all devices in a factory's IoT network. In this embodiment, with a single IDIC, a client can address all “Sensor Value” items in the network where the request is sent, either by unicasting the request to multiple devices or by using broadcasting. In another embodiment, the client can target specific devices in an IoT network when the sensors on each device have different IDICs.

In embodiments using a broadcast network, the same Req-BF may also include a sensor or server ID. Then the sensor or server receiving the broadcasted request can verify if this packet is addressed to it. If not, the packet is dropped at that node, and if yes, the item's IDICs are matched to further check what is requested from this node.

### Interaction Capabilities

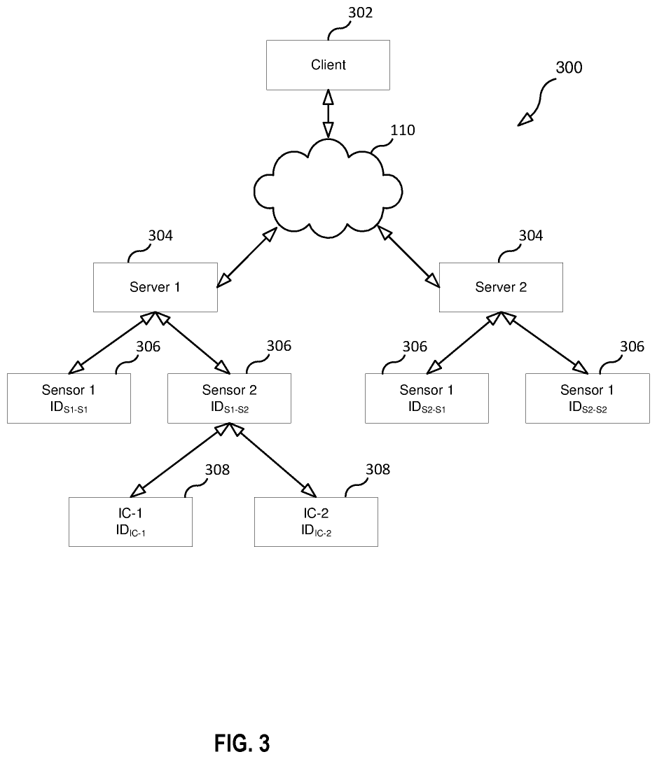

FIG. 3 illustrates a communication system 300 with a client 302 in communication with two servers 302 over a network 110. Each of the servers 304 has a plurality of sensors 306 with multiple interaction capabilities 308. In other embodiments, the communication system 300 may have any number of clients 302 and servers 304. Additionally, each of the servers 304 may have any number of sensors 306 with any number of interaction capabilities 308. The interaction capabilities 308 may be associated with different information that is measured and maintained in the sensor 306, or actuations that can trigger some actions on the sensor 306.

In some embodiments, the IDIC for an interaction capability may be created using a random algorithm. For example, an IDIC may be created by generating k different values between 1 and m (or between 0 and m−1) and setting those bits to one. In this embodiment, the IDICs of all interaction capabilities must be communicated to the client during a discovery phase as the client is not aware of them otherwise.

In an alternative embodiment, similar interaction capabilities in different sensors or devices (for example temperature sensors current value) have the same IDIC. In this embodiment, the IDIC may be created using hash functions.

The hash functions are known for all devices in the network, including the client and servers. As such the IDICs can be calculated at the client end without contacting the server. For example, having two hash functions (k=2), the client or server can run a first hash function and a second hash function and provide two values between 1 and m (or between 0 and m−1). Then, both the server, as well as the client, know the same IDIC. In this embodiment, the server may not send IDIC to the requesting client at any phase.

In another embodiment, a server or sensor may have an identifier, such as a UUID, which may be included in the calculation in the hash calculation phase. The client can get the universally unique identifier (UUID) information during a discovery phase from the server or sensor which can be used in the hash function calculations. As such, two different temperature sensors in different servers will have different IDICs. In this embodiment, the server does not send IDIC to the requesting client.

In other embodiments, the client may send the Req-BF to servers using a broadcast or multicast message. In such embodiment, or in any other embodiment described herein, an identifier identifying the server or sensor may be included in the Req-BF. The identifier may allow a server or sensor to know whether a Req-BF is targeting it based on the identifier.

Referring back to FIG. 3, the client 302 identifies the sensors 306 of the servers 304. In other embodiments, the servers 304 may contain any number of sensors, or other types of devices. Each of the sensors 306 contains a set of interaction capabilities 308. The sensor's 306 interaction capabilities 308 IDs in FIG. 3 are m-bit long identifiers to be included in the requesting Bloom filters.

As an illustrative example, a request Bloom filter (Req-BF) and the length of the IDICs may be set to be eight bits long, k=2 (number of bits set to “1” in the IDIC bit string), and n=number of items inserted in the Req-BF. In other embodiments, k may be the number of different hash functions that are used, each providing a value between 1 and m (or between 0 and (m−1)), that are used in the IDIC bitstring to set those bits to one.

The feasible sizes of Req-BF and IDICs can be estimated when the number of items to be added to the filter is roughly known. In FIG. 3 this means the number of sensors, interaction capabilities in sensors with different IDICs, and network topology is known.

In the next illustrative example, the client is sending a request, for example to a temperature sensor, defined in IPSO with ID 3303.

This illustrative example uses the IPSO Temperature sensor (IPSO 3303), and its resources Sensor value 5700, Timestamp 5518, Min measured value 5601, Max measured value 5602, and Reset Min and Max Measured Values 5605. The client prepares a request to get Sensor Value and Timestamp and then it initiates an action to reset the Max and Min values stored at the sensor. The client can determine that the identifiers for the interaction capabilities are Sensor Value=IDIC-1, Timestamp=IDIC-2, Min measured value=IDIC-3, Max measured value=ICIC-4, and Reset Min & Max values=IDIC-5 using hash functions. Table 1 below illustrates generating the IDICs using two different hash functions on the interaction capabilities (or resource IDs). The server may create a Req-BF by using logical OR operation and setting Req-BF=IDIC-1 OR IDIC-2 OR IDIC-3, where OR is a logical bitwise OR operation.

TABLE 1
Hashing IC strings and Creating IDICs

| Resource ID | Hash 1 | Hash 2 | IDIC |
|---|---|---|---|
| /3303/0/5700″ | 3 | 6 | IDIC-1 = 00100100 |
| /3303/0/5518 | 4 | 9 | IDIC-2 = 00010001 |
| /3303/0/5601 | 3 | 7 | IDIC-3 = 00100010 |
| /3303/0/5602 | 2 | 5 | IDIC-4 = 01001000 |
| /3303/0/5605 | 1 | 6 | IDIC-5 = 10000100 |

The client creating a request for <Sensor value, Timestamp> and a request to reset the stored minimum and maximum values may use the following:

$$Req - BF = IDIC - 1 OR IDIC - 2 OR IDIC - 5 = 10110101$$

A server receiving the Req-BF may match the item IDs that it has with the request message using the following:

$$Result = Req - BF AND IDIC - 1 XOR IDIC - 1 = 0$$

Result being 0 indicates a match. A match would also be found for the timestamp IDIC-2 and reset operation IDIC-5. However, for the Min measured value:

$$Result = Req - BF AND IDIC - 3 XOR IDIC - 3 = 00000010$$

Result is not equal to zero. As such there is no match with IDIC-3. There would also not be a match for Max measured value IDIC-4. As a result, the server will reply with the measured value, timestamp, and also initiate the activity to reset the currently stored min and max values.

For efficiency purposes, in some embodiments the matching operation in the sensor can be done in chunks, for example with a 128-bit IDs and Bloom filter, the matching can be done in 16-bit chunks. If there is a non-matching chunk, the operation can be stopped at that point.

In some embodiments, additional statement information may be included in the transmitted packet. In this embodiment, the client requests, for example, the temperature value only if it is greater than some determined value. Taking the previous example above:

$$\begin{matrix}IDIC - 1 = 00100100 \\ IDIC - 2 = 00010001 \\ IDIC - 3 = 00100010 \\ IDIC - 4 = 01001000 \\ IDIC - 5 = 10000100\end{matrix}$$

IDIC-6=01010000, the new statement information, in this case the statement is: “Greater than X”

The client can request, for example, Req-BF=IDIC-1+IDIC-6 and send to the server Req-BF followed by a field with the value “40”. The server verifies first the existence of statement IDIC-6, which indicates that the value must follow the Req-BF, gets the value from the message and makes the comparison to the “Statement: greater than X”, where X is the value 40. It returns the current temperature value if the statement matches. If there are multiple statements that require parameter values, they can be included for example in a predefined order in the message.

Requesting Information from Multiple Devices Using Broadcast/Multicast

In such embodiments where the client uses a multicast message or a broadcast message to send the request packet to multiple servers simultaneously, additional information may be added to the Req-BF also identifying sensors and/or servers. The identifying information allows a sensor and/or server to determine if the request message is for them before trying to match its information capability IDs to the incoming Req-BFs.

In some embodiments, each of the sensor IDICs may be the same for similar sensors. For example, “temperature sensor value” item could have the same IDIC bitstring for all sensors in different servers. Having the sensor interaction capability IDICs be the same allows a client to read all the values from different sensors using a single command broadcasted to all the servers. In this embodiment, a client may request, for example, all temperature values using a single item inserted in the Req-BF message which is broadcasted to the network (or multicast if the network is multicast capable). Each sensor with that particular interaction capability (temperature sensor value) that receives the Req-BF will respond with its value.

In other embodiments, the Req-BF can also contain the server ID to which the Req-BF is targeted. In this case, the server does not take the packet into handling unless its own identity is found from the Req-BF. This process would reduce also the traffic caused by false positive matchings in the servers.

In yet another embodiment, the sensor item IDs can be dependent on the server UUID. As such, giving statistically globally unique IDs for each sensor item, making it possible to address a specific sensor item even if the request message is broadcasted to multiple receiving sensors.

### Handling False Positive

In other embodiments, the Bloom filter matching has the feature that it may have false positive matches, in this case generating additional responses from the devices. This depends on the sizes of the filter (m), number of bits set to one in the identifiers (k) as well as on the number of items inserted in the filter (n).

In such embodiments, the Req-BF may get “too full” (i.e. having too many of the bits set to one) providing too many false responses due to false positive matches on the devices. This can be coped with by setting a maximum percentage of bits that are allowed to be set to one in the Req-BF and instead of putting all items into one Req-BF, the remaining items may be inserted into a second Req-BF, i.e., distributing the requests into two or more Req-BFs. Thus, creating multiple Req-BFs provides less false positives and better performance for the network. The receiving device gets all the Req-BFs and it verifies the IDs of the interaction capabilities with all of them.

### False Positive Calculation in Bloom Filters

In some embodiments, it is possible to estimate the false positive probabilities of a bloom filter. The calculations helps to set the optimal values for the bloom filter size (m) and number of bits set to one in identifiers (k) depending on the configuration and usage of the network and devices.

Requesting Information from a Specific Device

The illustrative example below shows a device with 20 Interaction Capabilities. Table 1 shows the false positive probability with a bloom filter size of 64 bits when either inserting 5 requests (n=5, m/n=12.8) or 10 requests (n=10, m/n=6.4) into the bloom filter. Table 2 shows the same results for a bloom filter size of 128 bits. False positive means here that in addition to the correct matches, one gets some additional matches.

TABLE 2
Bloom Filter Size: m = 64

| n (m/2) | k = 3 | k = 4 | k = 5 |
|---|---|---|---|
| 5 (12.8) | 0.9% | 0.5% | 0.3% |
| 10 (6.4) | 6.1% | 5.6% | 5.8% |

TABLE 3
Bloom Filter Size: m = 128

| n (m/2) | k = 3 | k = 4 | k = 5 |
|---|---|---|---|
| 5 (25.6) | 0.1% | 0.04% | 0.01% |
| 10 (12.8) | 0.9% | 0.5% | 0.3% |

Increasing the size of the bloom filter, i.e., the m value, the false positive probabilities will decrease if other values remain the same. Increasing k (the number of bits set to one of an interaction capability ID), changes also the probability values: for example, if n is 5 the false positive probabilities will decrease when k increases, but if m is set to 10, the false positive probability will start increasing already when k is greater than four.

In another illustrating example, a client is requesting information from multiple devices using Broadcast: request information from a network consisting of 100 nodes, with each having 20 Information Capabilities (all with different IDICs).

In this example there are two main use case scenarios: request three ICs from ten or twenty nodes, resulting in inserted items in the bloom filter n=3*10=30 and n=3*20=60, and verifying the requests using k values 3, 4, and 5. In this example, the needed size of m will be estimated. Following the data given in, m/n should be at least 7 to keep the false positive rate low (<5%). This means that in the case of sending three requests to 20 nodes, the m should be at least 60×7=420. Table 3 gives an example for m=512:

TABLE 4
Bloom Filter Size: m = 512, Inserting 30 and 60 Requests

| n (m/n) | k = 3 | k = 4 | k = 5 |
|---|---|---|---|
| 30 (17.1) | 0.4% | 0.2% | 0.1% |
| 60 (8.5) | 2.5% | 2% | 1.8% |

In this example, if one has 2000 items available in all the nodes receiving the request, with n=60 and k=4, one has a 2% false positive rate, and that would result in (2000−60)*0.02=38.8 false responses sent over the network in addition to the 60 correct replies. With n=30 and k=4, one has false positive rate 0.2% and only (2000−30)*0.002=3.9 false responses in addition to the 30 correct ones.

Using the same setting as in the example above, one can use two request bloom filters instead of one, thus having n=15 or n=30 inserted items in both of them. The effect on false positives for one request:

TABLE 5
Half of the Items Inserted into One Bloom Filter

| n (m/n) | k = 3 | k = 4 | k = 5 |
|---|---|---|---|
| 15 (34.1) | <0.07% | <0.02% | <0.006% |
| 30 (17.1) | 0.4% | 0.2% | 0.1% |

From this, one can estimate the corresponding false positive probability for total n=60 (two sent requests, both with n=30), where the false positive rate is 0.2%. This results in (2000−60)*0.002*2=7.8 falsely sent packets. With n=30 (two requests with n=15), one has false positive rate less than 0.02%, one gets (2000−30)*0.0002*2=0.8 falsely sent packets per request.

While adding the other request packet, the number of false positive packets will decrease remarkably. But as mentioned, this is for the case when there are lots of devices in the network, lots of ICs in them and requests contain multiple ICs

### IoT Scenario

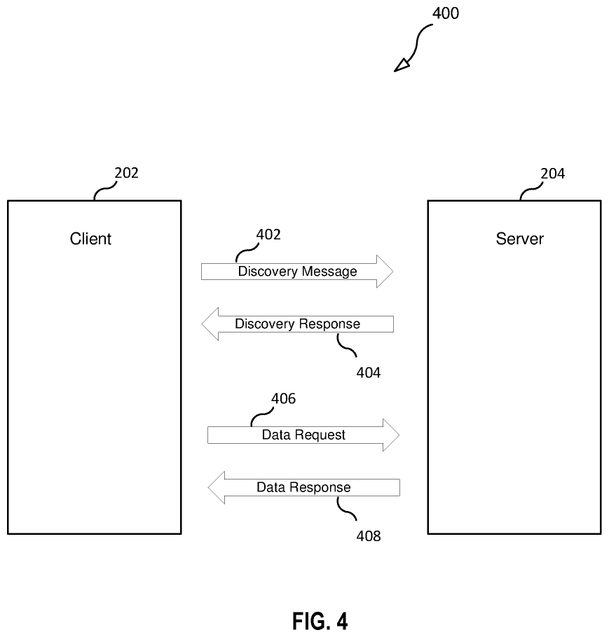

FIG. 4 illustrates an embodiment using a message exchange 400 between a client 202 and a server 204. In some embodiments, the message exchange 400 may be a CoAP message exchange. FIG. 4 first illustrates a traditional message exchange with the following sequence:

First, the client 202 transmits a discovery message 402 to the server 204. In some embodiments, the discovery message 402 may be a CoAP message (e.g., a Confirmable CoAP message comprising a GET request) for information from the server 204. The resource identifier (e.g., Uniform Resource Identifier (URI) or Uniform Resource Locator (URL)) included in the first line of the GET request may be a well-known resource identifier (e.g. “/.well-known/core”).

Then the server 204 may respond with a discovery response 404 message to the client 202. In some embodiments, the discovery response 404 may be an acknowledgment (ACK) message comprising a response containing a list of resource identifiers (i.e., interaction capabilities) available to be invoked by the client. The discovery response 404 may have a return code of 2.05 indicating the discovery response is part of a CoAP ACK message. Table 6 below shows a list of resource identifiers that may be returned in response message 404 together with return type (rt) information for the resource identifier.

<sensor/temp1>;rt=’temperatureC’
<sensor/temp2>;rt=’temperatureC’
<sensor/light>;rt=’LightLux’

In the above example, the server has two temperature sensors (temp1 and temp2) and a light sensor, and the client 202 may obtain the current temperature measurement from the temp1, the current temperature measurement from temp2, and the current light measurement from the light sensor. Conventionally, to obtain these three different measurement, the client would need to send three different requests to the server—i.e., one request for each one of the three measurements. For example, to obtain the current temperature measurement from temp1 the client could send the following request: GET /sensor/temp1.

When the server 204 receives a request (e.g., GET /sensor/temp1) the server will obtain the temperature value from temp1 and then transmit a data response 408 to the client containing the sensor value. In some embodiments, the data response 408 may be an ACK message containing the value.

To reduce the number of requests that the client sends to the server, the client can employ the Bloom filter. That is, each resource identifier (e.g., /sensor/temp1, /sensor/temp2, sensor/light) is associated with an m-bit string or k index values and the client can use the bit strings (or index values) to construct a Bloom filter that will identifier the resource identifiers selected by the client.

In this embodiment, the Discovery message 402 need not change.

The discovery response 404, however, may be the same or contain IDICs or index values for each resource identifier (i.e., /sensor/temp1, /sensor/temp2, /sensor/light/) depending on the IDIC generation solution chosen. For example, the discovery response 404 may contain the following information (“</sensor/temp>;rt=“TempratureC”;if=“ ”;ct=0”, </sensor/light>;rt=“LightLux”;if=“ ”;ct=“0”). In this case, the client will use the k hash function to produce, for each resource identifier, the k index values. As another example, the discovery response 404 may contain the following list of three information elements (a.k.a., items): ([IDIC-1, </sensor/temp1>, rt=“TemperatureC”], [IDIC-2, </sensor/temp2>, rt=“TemperatureC”], [IDIC-3, </sensor/light>,rt=“lightLux” ]), where each item in the list includes: an IDIC value, a resource identifier corresponding to the IDIC value, and a return type indicator.

In other embodiments, if the interaction with the server 204 is done with a well-known data model such as IPSO, the bloom filter could be used to match the syntax of the data model with the bloom filter.

For example, IPSO values that could be match easily are “current value”, “measured max value”, “measured min value”, and “resetting the min and max values”.

An example of an IPSO request in CoAP is:
GET /3303/1/5700 where 3303 is the IPSO identifier of the object (in this case a thermometer), 1 is the instance of the object (there can be multiple instances of an object of type thermometer), and 5700 is the resource of the thermometer object that gives us access to what the thermometer measures (also known as “Sensor Value”).

The following example shows a more complex example where different IPSO values are combined:
GET /3303/0/5700; GET /3303/0/5601; 3303/0/5602; 3303/0/5605.

This complex example could be easily matched with a bloom filter. Using the Req-BF, one would insert these in it:

$$ReqBF = ( IDVF 5700 ) OR ( IDBF 5601 ) OR ( IDBF 5602 ) OR ( IDBF 5605 )$$

Instead of sending a CoAP GET request for each IPSO value, one can now send single CoAP GET message with a Req-BF containing all identifiers for the requested Interaction Capabilities.

The IoT device will make matching with all the identifiers it has, and it will react accordingly in each match. In this particular case, it will respond with the temperature value, min value, and max value. In addition, the min and max values are reset in the IoT device.

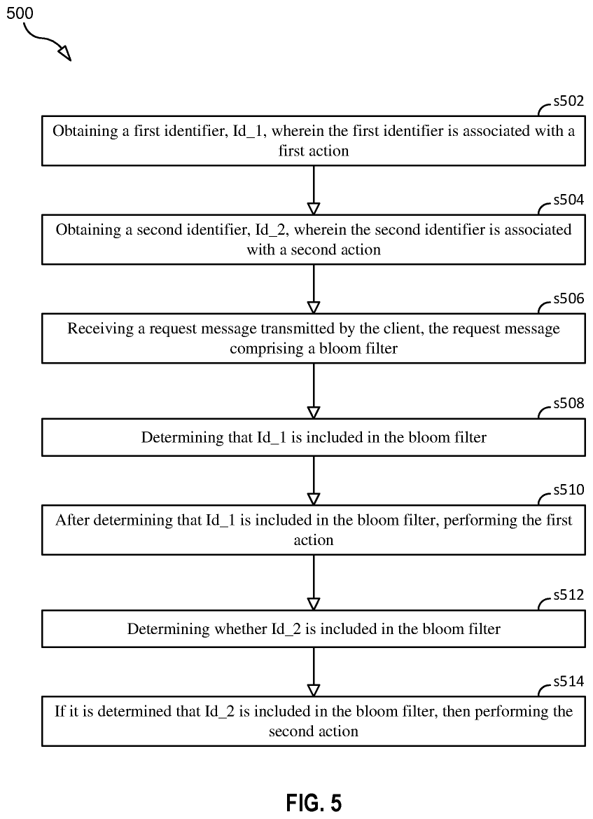

FIG. 5 is a flowchart illustrating a process 500, according to an embodiment, performed by server 204 capable of being requested by client 202 to perform one or more actions. Process 500 may begin in step s502.

Step s502 comprises obtaining a first identifier, Id_1, wherein the first identifier is associated with a first action.

Step s504 comprises obtaining a second identifier, Id_2, wherein the second identifier is associated with a second action.

Step s506 comprises receiving a request message transmitted by the client, the request message comprising a bloom filter.

Step s508 comprises determining that Id_1 is included in the bloom filter.

Step s510 comprises after determining that Id_1 is included in the bloom filter, performing the first action.

Step s512 comprises determining whether Id_2 is included in the bloom filter.

Step s514 comprises if it is determined that Id_2 is included in the bloom filter, then performing the second action.

In some embodiments, the bloom filter consists of a string of M bits, and determining that Id_1 is included in the string of M bits comprises determining that Id_1 & B equals Id_1, where B is the string of M bits and & is a bitwise AND operator (e.g., determining that Id_1 & B==Id_1 comprises determining that Id_1 & B XOR Id_1 equals 0, where XOR is a bitwise XOR operator).

In some embodiments, the process may further include prior to receiving the request message, receiving a discovery message transmitted by the client (e.g., a message that contains a well-known URI such as “/.well-known/core”); and transmitting to the client a discovery response message responsive to the discovery message, the discovery response message comprising: i) a first information element (e.g., a first item in a list of items) comprising Id_1 and a first resource identifier and ii) a second information element comprising Id_2 and a second resource identifier.

In some embodiments, the process may further include prior to determining that Id_1 is included in the bloom filter, the server determining that the request message is addressed to the server, wherein the server determines whether Id_1 is included in the bloom filter after determining that the request message is addressed to the server.

In some embodiments, determining that the request message is addressed to the server comprises determining that a server identifier allocated to the server is included in the bloom filter.

In some embodiments, obtaining the first identifier comprises: generating the first identifier using one or more hash functions; generating the first identifier using a randomization process; or receiving the first identifier from a second device.

In some embodiments, the process may further include: obtaining a statement identifier, Id_S, wherein the statement identifier is associated with a conditional statement; determining that Id_S is included in the bloom filter; after determining that Id_S is included in the bloom filter, determining if the conditional statement is met; and as a result of the conditional statement being met, performing the first action

In some embodiments, the request message is addressed to a group of servers comprising the server, or the request message is addressed to any server

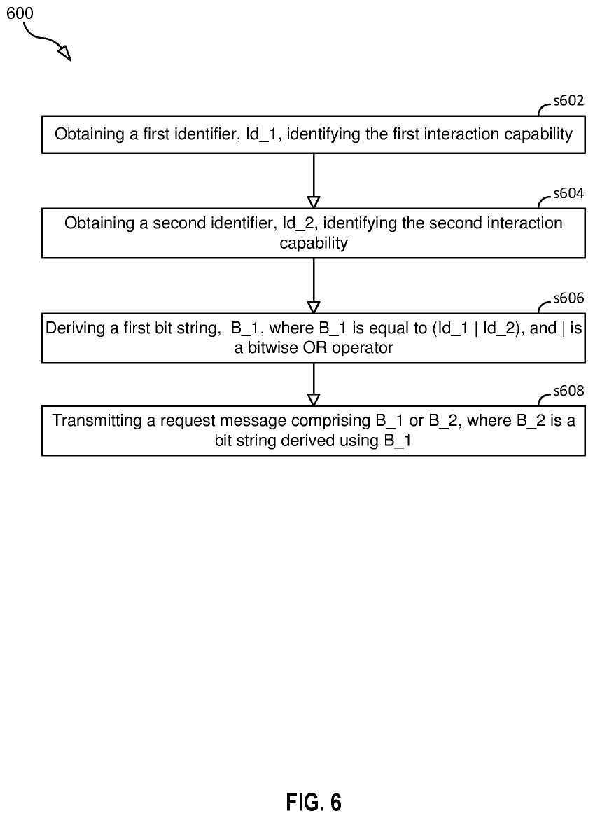

FIG. 6 is a flowchart illustrating a process 600, according to an embodiment, for communicating to at least a first server information identifying a set of interaction capabilities (e.g. a set of resources), the set of interaction capabilities comprising a first interaction capability and a second interaction capability. Process 600 may begin in step s602.

Step s602 comprises obtaining a first identifier, Id_1, identifying the first interaction capability.

Step s604 comprises obtaining a second identifier, Id_2, identifying the second interaction capability.

Step s606 comprises deriving a first bit string, B_1, where B_1 is equal to (Id_1 Id_2), and | is a bitwise OR operator.

Step s608 comprises transmitting a request message comprising B_1 or B_2, where B_2 is a bit string derived using B_1.

In some embodiments, the message comprises B_2, B_2 equals B_1|Id_3 or B Id_3, where B was derived using B_1, and Id_3 is a third identifier identifying a third interaction capability. In other embodiments, B_2 equals B_1|Id_server or B|id_server, where B was derived using B_1, and Id_server is an identifier for identifying the first server.

In some embodiments, the process may further include: obtaining a maximum bit value, wherein the maximum bit value indicates a maximum number of bits of the first bit string which may be set to 1; determining a bit string value, the bit string value being the number of bits set to 1 in the first bit string; comparing the bit string value to the maximum bit value, wherein the step of transmitting the request message is performed as a result of the bit string value being less than the maximum bit value.

In some embodiments, the message comprises B_2, B_2 equals B_1|Id_s or B|id_s, where B was derived using B_1, and Id_s is an identifier identifying a conditional statement.

In some embodiments, the request message is addressed to a group of servers comprising the first server, or the request message is addressed any server.

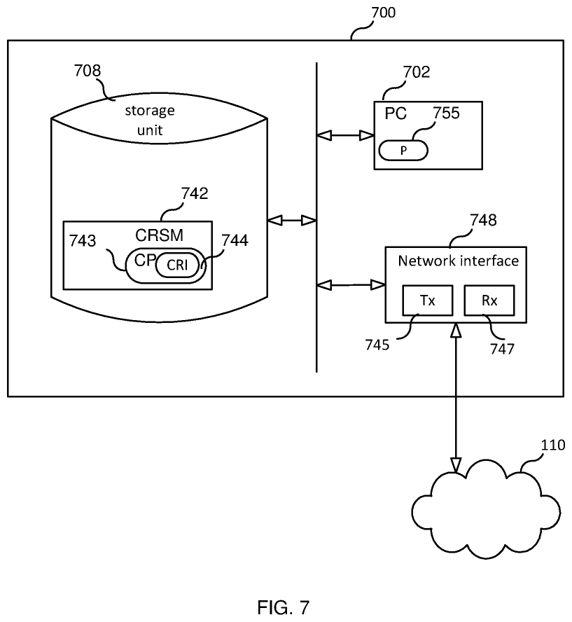

FIG. 7 is a block diagram of an apparatus 700 for implementing a client (e.g., 202, 302) and/or a server (e.g., 204, 304), according to some embodiments. As shown in FIG. 7, apparatus 700 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., encoder apparatus 700 may be a distributed computing apparatus); at least one network interface 748 (e.g., a physical interface or air interface) comprising a transmitter (Tx) 745 and a receiver (Rx) 747 for enabling apparatus 700 to transmit data to and receive data from other nodes connected to a network 110 (e.g., an Internet Protocol (IP) network) to which network interface 848 is connected (physically or wirelessly) (e.g., network interface 748 may be coupled to an antenna arrangement comprising one or more antennas for enabling encoder apparatus 700 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes encoder apparatus 700 to perform steps described herein (e.g., steps described herein with reference to the flow charts). In other embodiments, encoder apparatus 700 may be configured to perform steps described herein without the need for code. That is, for example, PC 702 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other devices are used to relay the message from the source device to the intended recipient). Likewise, as used herein receiving a message “from” a sender encompasses receiving the message directly from the sender or indirectly from the sender (i.e., one or more devices are used to relay the message from the sender to the receiving device). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a server capable of being requested by a client to perform one or more actions, the method comprising:
obtaining a first identifier (Id_1), wherein the first identifier is associated with a first action;
obtaining a second identifier (Id_2), wherein the second identifier is associated with a second action;
receiving a request message transmitted by the client, the request message comprising a bloom filter;
determining that Id_1 is included in the bloom filter;
after determining that Id_1 is included in the bloom filter, performing the first action;
determining whether Id_2 is included in the bloom filter; and
if it is determined that Id_2 is included in the bloom filter, then performing the second action.

2. The method of claim 1, wherein
the bloom filter consists of a string of M bits, and
determining that Id_1 is included in the string of M bits comprises determining that Id_1 & B equals Id_1, where B is the string of M bits and & is a bitwise AND operator.

3. The method of claim 1, further comprising:
prior to receiving the request message, receiving a discovery message transmitted by the client; and
transmitting to the client a discovery response message responsive to the discovery message, the discovery response message comprising: i) a first information element comprising Id_1 and a first resource identifier and ii) a second information element comprising Id_2 and a second resource identifier.

4. The method of claim 1, further comprising:
prior to determining that Id_1 is included in the bloom filter, the server determining that the request message is addressed to the server, wherein
the server determines whether Id_1 is included in the bloom filter after determining that the request message is addressed to the server.

5. The method of claim 4, wherein determining that the request message is addressed to the server comprises determining that a server identifier allocated to the server is included in the bloom filter.

6. The method of claim 1, wherein obtaining the first identifier comprises:
generating the first identifier using one or more hash functions;
generating the first identifier using a randomization process; or
receiving the first identifier from a second device.

7. The method of claim 1, the method further comprising:
obtaining a statement identifier (Id_S), wherein the statement identifier is associated with a conditional statement;
determining that Id_S is included in the bloom filter;
after determining that Id_S is included in the bloom filter, determining if the conditional statement is met; and
as a result of the conditional statement being met, performing the first action.

8. The method of claim 1, wherein
the request message is addressed to a group of servers comprising the server, or
the request message is addressed to any server.

9. A method for communicating to at least a first server information identifying a set of interaction capabilities, the set of interaction capabilities comprising a first interaction capability and a second interaction capability, the method comprising:
obtaining a first identifier (Id_1), identifying the first interaction capability;
obtaining a second identifier (Id_2), identifying the second interaction capability;
deriving a first bit string (B_1), where B_1 is equal to (Id_1|Id_2), and | is a bitwise OR operator; and
transmitting a request message comprising B_1 or B_2, where B_2 is a bit string derived using B_1.

10. The method of claim 9, wherein
the message comprises B_2,
B_2 equals B_1|Id_3 or B|Id_3, where B was derived using B_1, and
Id_3 is a third identifier identifying a third interaction capability.

11. The method of claim 9, wherein
the message comprises B_2,
B_2 equals B_1|Id_server or B|id_server, where B was derived using B_1, and
Id_server is an identifier for identifying the first server.

12. The method of claim 9, the method further comprising:
obtaining a maximum bit value, wherein the maximum bit value indicates a maximum number of bits of the first bit string which may be set to 1;
determining a bit string value, the bit string value being the number of bits set to 1 in the first bit string;
comparing the bit string value to the maximum bit value, wherein
the step of transmitting the request message is performed as a result of the bit string value being less than the maximum bit value.

13. The method of claim 9, wherein
the message comprises B_2,
B_2 equals B_1|Id_s or B|Id_s, where B was derived using B_1, and
Id_s is an identifier identifying a conditional statement.

14. A server capable of being requested by a client to perform one or more actions, the server being configured to:
obtain a first identifier (Id_1), wherein the first identifier is associated with a first action;
obtain a second identifier (Id_2), wherein the second identifier is associated with a second action;
receive a request message transmitted by the client, the request message comprising a bloom filter;
determine that Id_1 is included in the bloom filter;
after determining that Id_1 is included in the bloom filter, perform the first action;
determine whether Id_2 is included in the bloom filter; and
if it is determined that Id_2 is included in the bloom filter, then perform the second action.

15. The server of claim 14, wherein
the bloom filter consists of a string of M bits, and
determining that Id_1 is included in the string of M bits comprises determining that Id_1 & B equals Id_1, where B is the string of M bits and & is a bitwise AND operator.

16. A client for communicating to at least a first server information identifying a set of interaction capabilities, the set of interaction capabilities comprising a first interaction capability and a second interaction capability, the client being configured to:
obtain a first identifier (Id_1), identifying the first interaction capability;
obtain a second identifier (Id_2), identifying the second interaction capability;
derive a first bit string (B_1), where B_1 is equal to (Id_1|Id_2), and | is a bitwise OR operator; and
transmit a request message comprising B_1 or B_2, where B_2 is a bit string derived using B_1.

17. The client of claim 16, wherein
the message comprises B_2,
B_2 equals B_1|Id_3 or B|Id_3, where B was derived using B_1, and
Id_3 is a third identifier identifying a third interaction capability.
